(19) United States
(12) Patent Application Publication
(10) Pub. No.: US 2007/0274170 A1
(43) Pub. Date: Nov. 29, 2007

(54) Suspension in an Actuator for Displacing a Lens Holder

(75) Inventor: Cornelius Maria Wouters, Eindhoven (NL)

Correspondence Address: BAINWOOD HUANG & ASSOCIATES LLC, 2 CONNECTOR ROAD, WESTBOROUGH, MA, 01581, US

(73) Assignee: Arima Devices Corporation, Road Town, Tortola (VG)

(21) Appl. No.: 10/590,134

(22) PCT Filed: Feb. 10, 2005
(86) PCT No.: PCT/IB05/50522

§ 371 Date: Apr. 16, 2007

(30) Foreign Application Priority Data
Feb. 20, 2004 (EP) 04100685.9

(51) Int. Cl. G11B 7/09

(52) U.S. Cl. 369/44.15

(57) ABSTRACT

An actuator for moving a lens having an optical axis (41), which actuator comprises a stationary section (102), a movable section (104) provided with the lens (45), and an electric driving means for driving the movable section. The movable section is suspended from the stationary section by two suspension sets (106; 108) of at least three elongate members of which respective end portions are secured to the stationary section and other end portions are secured to the movable section by means of mechanical connections. One of the sets extends at one side (104a) of the optical axis and the other set extends at an opposite side (104b) of the optical axis. In order to improve the mechanical behavior of the actuator, the mechanical connections needed for securing at least two elongate members (106b; 108b) of each set are rigid connections, while at least one of the mechanical connections needed for securing each other elongate member (106a, 106c; 108a, 108c) of each set is a flexible connection.

The invention relates to an actuator for moving a lens system having an optical axis, which actuator comprises a stationary section, a movable section provided with the lens system, and an electric driving means for driving the movable section, wherein the movable section is suspended from the stationary section by two suspension sets of at least three elongate members of which respective end portions are secured to the stationary section and other end portions are secured to the movable section by means of mechanical connections, one of the sets extending at a side of the optical axis and the other set extending at another, opposite side of the optical axis.

US-A 2003/0156529 discloses an actuator for displacing a lens holder with an objective lens of the sort as used in optical systems such as CD-systems and DVD-systems. The lens holder is supported by a linear suspension so as to be displaceable with respect to a fixing member fixed to a housing. The suspension is formed by a system of suspension wires of which one end is fixed to the fixing member and the other end is fixed to the lens holder. The system of suspension wires consists of two sets of three wires each, the lens holder extending between the two sets. The known actuator comprises tracking coils, a focusing coil, and tilt coils provided in the lens holder, and a magnet unit fixed to the housing. The movement of the objective lens is controlled through interaction between the magnet unit and magnetic fields generated by said coils.

Such a six-wire actuator is becoming more and more common in optical pick-up units, particularly units which are applied in high data-density optical systems, for controlling tracking, focusing, and tilting movements of the lens holder in order to pursue an exact position and orientation of the lens with respect to an information layer of an optical disc to be scanned at each moment during use.

It has been observed that the use of sets of three suspension wires give rise to problems as to the focusing and/or tracking behavior of the lens holder.

It is an object of the invention to improve the mechanical behavior of an actuator having two sets of at least three linear suspension members.

This object is achieved by the actuator according to the invention, which comprises a stationary section, a movable section provided with a lens system, and an electric driving means for driving the movable section, wherein the movable section is suspended from the stationary section by two suspension sets of at least three elongate members of which respective end portions are secured to the stationary section and other end portions are secured to the movable section by means of mechanical connections, one of the sets extending at a side of the optical axis and the other set extending at another, opposite side of the optical axis, wherein the mechanical connections needed for securing at least two elongate members of each set are rigid connections, while at least one of the mechanical connections needed for securing each other elongate member of each set is a flexible connection.

The measures applied in the actuator according to invention prevent that great axial forces are caused in the elongate members because of mutually different lengths and/or a misalignment of the elongate members of a suspension set during displacements, particularly in focusing and/or tracking directions, of the movable section. Great axial forces in the elongate members lead to an increase in stiffness of the suspension, resulting in a considerable increase in energy consumption. Moreover, varying axial forces in the elongate members jeopardize a long lifetime of the actuator. The actuator according to the invention typically does not suffer from these problems thanks to the application of flexible connections.

A practical embodiment of the actuator according to the invention has the characteristic feature that the number of elongate members of each supporting set is three. Two of the members of each set are considered to be suspension members, i.e. members which virtually serve for suspending the movable section, while the third one of each set is considered to be an auxiliary member, which mainly serves for other purposes, such as conducting signals. Generally, all the elongate members of the two suspension sets are electrically conductive. The above-identified suspension members are rigidly fixed to both the stationary section and the movable section. The above-identified auxiliary member is flexibly fixed to at least one of the sections mentioned, thus one connection of the auxiliary member may be a rigid connection.

For reasons of manufacturing technology, the flexible connections are preferably provided on the stationary section. The flexible connection preferably comprises a resilient element, such as a tag, a tongue or something similar. The rigid connection comprises, as usual, a stiff element, such as a stud, protrusion, or the like. The elongate members are attached to the resilient elements and the stiff elements, respectively, by means of a suitable adhesive, such as a UV-curing glue, or by soldering or some other suitable technique.

It is to be noted that JP-A 2001-154986 discloses an optical head device with an objective lens holder which is suspended from a fixing block by means of four wire springs. The lens holder is further provided with two wire springs each having a free end in the neighborhood of the fixing block. All of the wire springs are electrically conductive for transmitting electrical signal to coils in order to control tracking, focusing, and tilting movements of the lens holder. The dynamic behavior of a wire spring having only one fixed end is different from the dynamic behavior of a wire spring having two fixed ends. For this reason the arrangement of wire springs used in the known head device causes an extra load for the servo control system of the device. The arrangement of wire springs further causes manufacturing problems because the assembling process is unfavorably influenced by the free, i.e. non-mounted, ends of two of the available free wire springs.

The invention further relates to an optical device for scanning an optical record carrier, which device is provided with an optical scanning unit provided with the actuator according to the invention. The device according to the invention may be further provided with an electric drive for moving the optical record carrier, particularly rotating the record carrier. Such a device is suitable for scanning an optical disc, such as a CD, a DVD, a variant thereof, or any other kind of optical disc.

With reference to the claims, it is to be noted that various characteristic features as defined in the set of claims may occur in combination.

The above-mentioned and other aspects of the invention are apparent from and will be elucidated, by way of non-limitative example, with reference to the embodiments described hereinafter.

In the drawings:

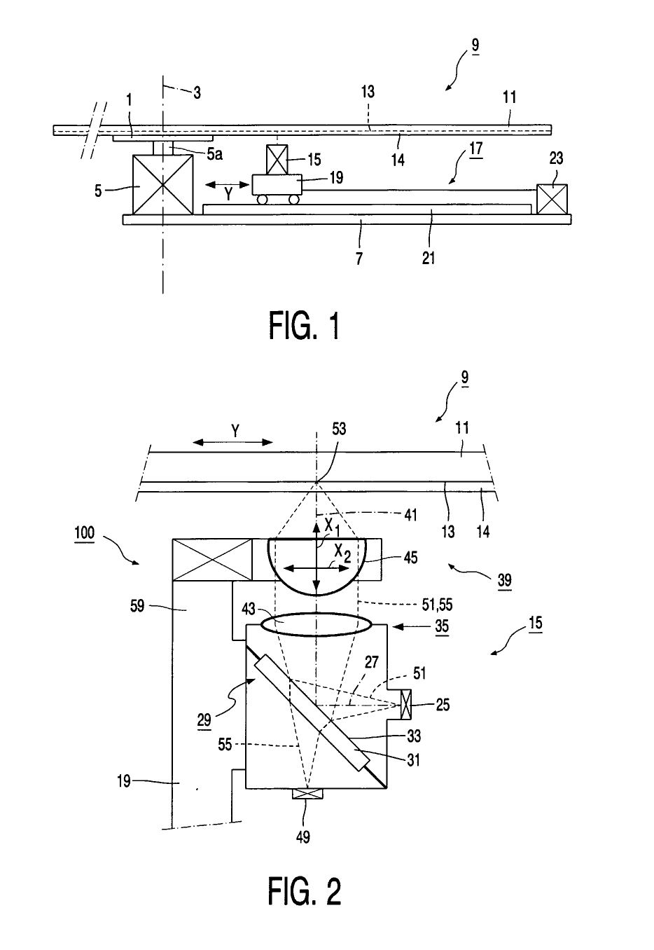

FIG. 1 diagrammatically shows an embodiment of the optical device in accordance with the invention,

FIG. 2 diagrammatically shows an optical scanning device employed in the optical player shown in FIG. 1,

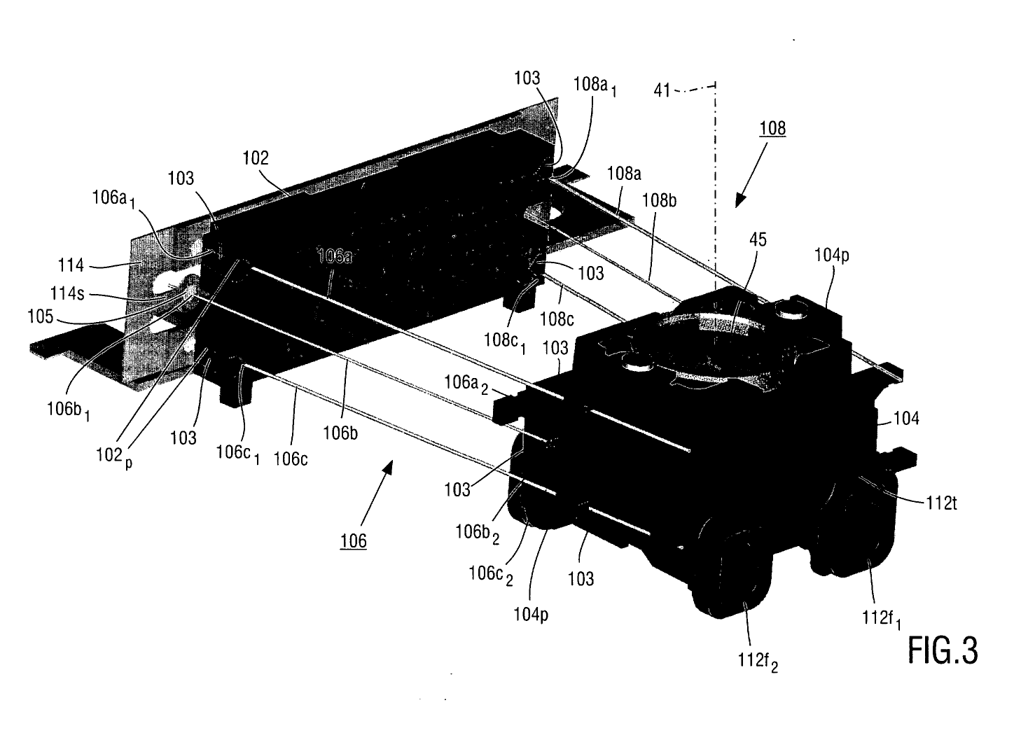

FIG. 3 is a perspective view of a portion of an embodiment of the actuator in accordance with the invention,

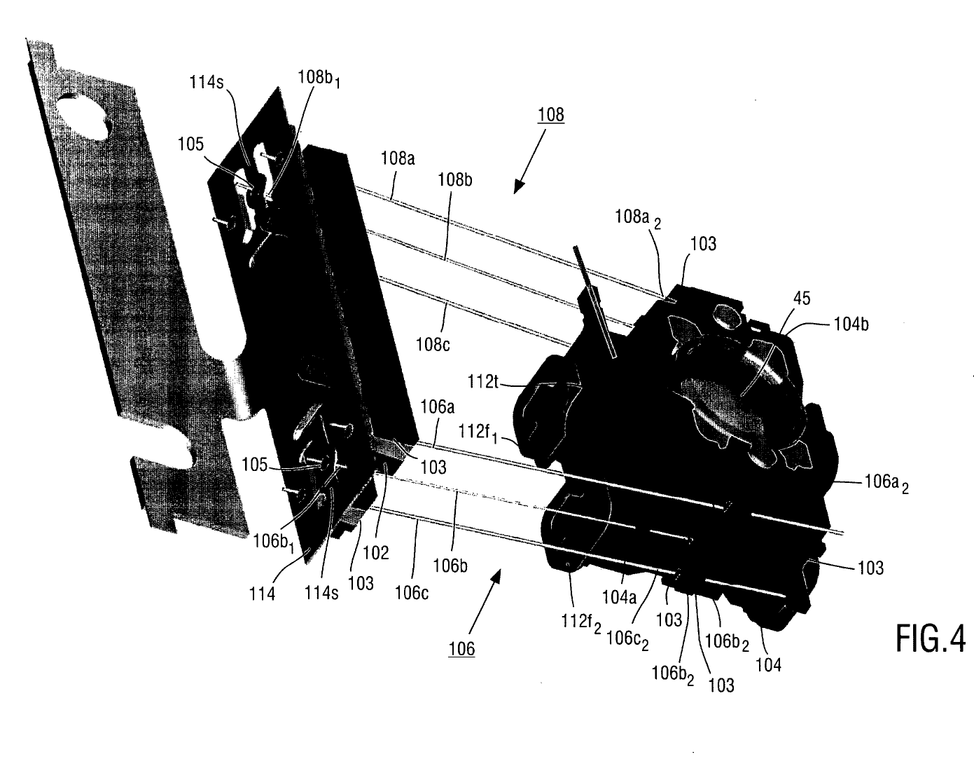

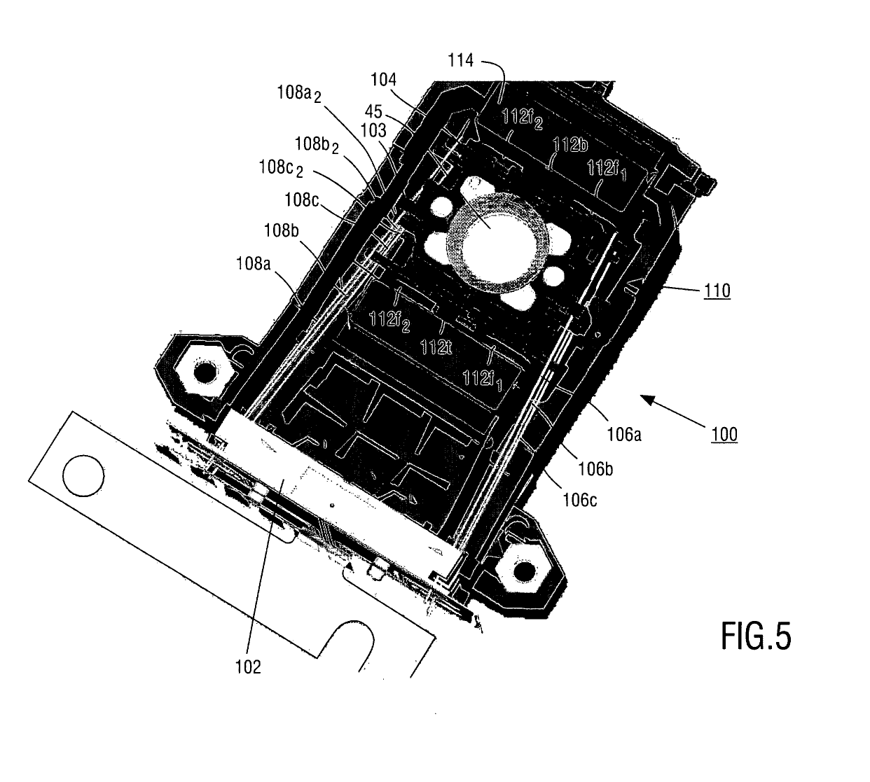

FIG. 4 is another perspective view of the portion of the actuator shown in FIG. 3, and

FIG. 5 is a perspective view of the actuator in accordance with FIG. 3.

It is to be noted that the Figures should be considered to be drawn not on scale.

Moreover, generally identical components are denoted by the same reference signs in the Figures.

FIG. 1 diagrammatically shows an optical device in accordance with the invention, also denoted optical player below. The optical player comprises a turntable 1, which can be rotated about an axis of rotation 3 and driven by means of an electric motor 5, which is secured to a frame 7. The turntable is secured to a motor shaft 5a of the electric motor 5. An optical record carrier, i.e. an optically scannable information carrier such as a CD or DVD, can be placed on the turntable 1. The carrier 9 is provided with a disc-shaped substrate 11 on which an information layer 13 having an information track is present. The information layer 13 is covered with a transparent protective layer 14. The optical player further comprises an optical scanning unit 15 for optically scanning the information track present on the information layer 13 of the information carrier 9. The scanning unit 15 can be displaced with respect to the axis of rotation 3 predominantly in two mutually opposed radial directions Y by means of a displacement unit 17 of the optical player. For this purpose, the scanning unit 15 is secured to a slide 19 of the displacement unit 17, and the displacement unit 17 is provided with a straight guide 21 over which the slide 19 is displaceably guided. The straight guide 21 is provided on the frame 7 and extends in the Y-directions, and the displacement unit 17 is further provided with an electric motor 23 by means of which the slide 19 can be displaced over the guide 21. In operation, the control of the electric motors 5 and 23 takes place by an electric control unit of the optical player, not shown in the drawings, and as a result, the rotation of the information carrier 9 about the axis of rotation 3 and, simultaneously, the displacements of the scanning unit 15 in the Y directions are carried out such that the information track present on the information layer 13 of the information carrier 9 is scanned by the scanning unit 15. During scanning, information present on the information track can be read by the scanning unit 15 or information can be written on the information track by this unit 15. Instead of the use of a turntable, it is alternatively possible to directly secure the optical record carrier to the shaft 5a of the electric motor 5. It is further possible to replace the slide 19 and the guide 21 by a so-called swing-arm device known per se.

An example of the optical scanning unit 15 employed in the optical player in accordance with the invention is diagrammatically shown in FIG. 2. The scanning unit 15 is provided with a radiation source 25, such as a semiconductor laser, having a beam axis 27. The scanning unit 15 comprises a radiation beam splitter 29 having a transparent plate 31 arranged at an angle of 45° with respect to the axis 27 of the radiation source 25 and provided with a reflective surface 33 facing the radiation source 25. The scanning unit 15 also comprises a collimator lens unit 35 and an optical lens system 39 with an optical axis 41, the collimator lens unit 35 being arranged between the radiation beam splitter 29 and the lens system 39. In the example shown, the collimator lens unit 35 comprises a single collimator lens 43, while the lens system 39 comprises a single objective lens 45. In this example the objective lens 45 and the collimator-lens 43 have the same optical axis 41. The optical axis 41 encloses an angle of 90° with the beam axis 27 of the radiation source 25. The scanning unit 15 further comprises an optical detector 49, which is of a well-known, commonly used type, and which is arranged, with respect to the collimator lens unit 35, behind the radiation beam splitter 29. In operation, the radiation source 25 generates a radiation beam 51 which is reflected by the reflective surface 33 of the radiation beam splitter 29 and focused by the lens system 39 into a scanning spot 53 on the information layer 13 of the information carrier 9. The radiation beam 51 is reflected by the information layer 13 so as to form a reflected radiation beam 55 which is focused on the optical detector 49 via the lens system 39, the collimator lens unit 35, and the radiation beam splitter 29. To read information present on the information carrier 9, the radiation source 25 generates a continuous radiation beam 51, and the optical detector 49 supplies a detection signal that corresponds to a series of elementary information characteristics on the information track of the information carrier 9, which elementary information characteristics are successively present in the scanning spot 53. To write information on the information carrier 9, the radiation source 25 generates a radiation beam 51 which corresponds to the information to be written, a series of successive, elementary information characteristics being generated in the scanning spot 53 on the information track of the information carrier 9. It is to be noted that the invention also covers optical scanning devices wherein the radiation source 25, the collimator lens unit 35, and the lens system 39 are differently arranged with respect to each other. For example, the invention also relates to includes embodiments wherein the optical axis of the collimator lens unit 35 and the optical axis of the lens system 39 enclose an angle of 90°, and wherein an additional mirror is arranged between the collimator lens unit 35 and the lens system 39. The invention further includes, for example, embodiments wherein the radiation source and the collimator lens unit are not arranged on a slide but in a fixed position with respect to the frame, and wherein the optical axis of the collimator lens unit is directed so as to extend parallel to the radial directions Y. In such embodiments, only the lens system 39 and an additional mirror may be provided on the slide 19, so that the displaceable mass of the slide is reduced.

As is further shown in FIG. 2, the optical scanning unit 15 comprises an actuator 100 according to the invention, which will be discussed in greater detail hereinafter, by means of which the lens system 39, particularly the lens 45, can be displaced with respect to a stationary part 59 of the scanning unit 15 secured to the slide 19, over comparatively small distances in first directions X₁ parallel to the optical axis 41, and over comparatively small distances in second directions X₂, which are perpendicular to the first directions X₁ and parallel to the Y-directions. Displacing the lens system 39 in a first direction X₁ by means of the actuator 100 focuses the scanning spot 53 with the desired accuracy on the information layer 13 of the information carrier 9. Displacing the lens system 39 in a second direction X₂ by means of the actuator 100 keeps the scanning spot with the desired accuracy on the information track to be followed. The lens system 39 can also perform tilt movements, will be as further explained hereinafter. The actuator 100 is controlled by a control unit of the optical player, which receives both a focusing error signal and a tracking error signal from the optical detector 49.

The actuator 100 shown in FIGS. 3, 4 and 5 has a stationary section 102, which is secured to the stationary part 59 of the scanning unit 15. The actuator 100 further has a movable section 104 carrying the lens system 39 with the objective lens 45. Moreover, the actuator 100 has an electric, particularly electromagnetic, driving unit 110 by means of which the movable section 102 and thus the lens system 39 and the lens 45 can be displaced with respect to the stationary section 102. The movable section 104 is suspended from the stationary section 102 by means of two suspension sets 106 and 108. These sets 106 and 108 each comprise three suspension wires 106a, 106b, 106c and 108a, 108b, 108c, respectively. In this example, all of the suspension wires are electrically conductive. The suspension set 106 extends at one side of the optical axis 41, i.e. near a first lateral side 104a of the movable section 104, and the other suspension set 108 extends at another, opposite side of the optical axis 41, i.e. near a second lateral side 104b of the movable section 104. The driving unit 110 comprises an electric coil system and a magnetic system, both systems being meant for cooperating with each other across an air gap during use of the actuator 100. In this example, the coil system comprises two coil sets each formed by a tracking coil 112t, i.e. a coil for correction of the position of the lens system 39 in a direction perpendicular to the information track on the record carrier to be scanned, and a pair of focusing coils i.e. coils 112f₁, 112f₂, for correction of the position of the lens system 39 along the optical axis 41. Each set of tracking coil 112t and focusing coils 112f₁, 112f₂ is attached to the movable section 104 and substantially extends in a narrow zone which is directed substantially perpendicularly to the suspension wires. The magnetic system, which is attached to the stationary section 102, comprises two magnetic units each provided with a permanent magnet 114 located opposite to one of the coil sets, the movable section 104 extending between the coil sets.

The arrangement of coil system and magnetic system enables the movable section 104 to be tilted in dependence of the control of the electric currents applied to the coils of the coil system. A separate control of the electric currents to the coils 112t, 112f₁, 112f₂ serves to generate translations of the movable section 104, and thus of the lens system 39 and the objective lens 45, in the directions X₁ parallel to the optical axis 41 and in the directions X₂ perpendicular to the optical axis 41, and to tilting of the movable section 102, and thus of the lens system 39 and the objective lens 45, about an axis extending in direction X₁ and/or direction X₂. The directions X₁ and X₂ are depicted in FIG. 2. For realizing said control of the electric currents, all of the wires of both suspension sets 106 and 108 are used as conductors.

Reference is made to WO 03/102929-A2 here, in which detailed information can be found about an arrangement such as the present one of coil system and magnet system.

In the actuator according to the invention, two of the wires of each suspension set 106, 108 serve as suspension wires. These wires are 106a, 106c and 108a, 108c, respectively. The end portions 106a₁, 106c₁, 108a₁, 108c, and 106a₂, 106c₂, 108a₂, 108c₂ of these wires are rigidly fixed to the stationary section 102 and the movable section 104, respectively. This fixation has been realized by means of rigid mechanical connections comprising solid portions of the stationary section 102 and the movable section 104, respectively, to which said end portions are attached by means of an adhesive 103. The solid portions are indicated by 102ₚ and 104ₚ, respectively.

The other wires 106b and 108b have end portions 106b₁, 106b₂ and 108b₁, 108b₂. In this example the end portions 106b₁ and 108b₁ are flexibly connected to the stationary section 102 by means of a flexible mechanical connection in the form of resilient butt-straps 114s of a flexible foil 114 secured to and forming part of the stationary section 102. The end portions 106b₁ and 108b₁ are attached to the butt-straps 114s by means of a dot of solder 105.

The other end portions 106b₂ and 108b₂ are rigidly attached to the movable section 104 in a same way as the end portions of the wires 106a, 106c, 108a, 108c are attached, i.e. fixed to the solid portions 102ₚ and 104ₚ, respectively.

Several variants of the disclosed embodiment are possible within the scope of the invention. For example, it is possible to make use of blade springs instead of wires as the elongate suspension elements.

1. An actuator for moving a lens system having an optical axis, which actuator comprises a stationary section, a movable section provided with the lens system, and an electric driving means for driving the movable section, wherein the movable section is suspended from the stationary section by two suspension sets of at least three elongate members of which respective end portions are secured to the stationary section and other end portions are secured to the movable section by means of mechanical connections, one of the sets extending at a side of the optical axis and the other set extending at another, opposite side of the optical axis, wherein the mechanical connections needed for securing at least two elongate members of each set are rigid connections, while at least one of the mechanical connections needed for securing each other elongate member of each set is a flexible connection.

2. An actuator as claimed in claim 1, wherein the number of elongate members of each set is three, each member being electrically conducting, and wherein only one of the elongate members of each set is secured by means of a flexible connection.

3. An actuator as claimed in claim 1, wherein the flexible connections are provided on the movable section.

4. An actuator as claimed in claim 1, wherein each flexible connection comprises a resilient element.

5. An optical device for scanning an optical record carrier, provided with an optical scanning unit and an actuator for moving a lens system having an optical axis, which actuator comprises a stationary section, a movable section provided with the lens system, and an electric driving means for driving the movable section, wherein the movable section is suspended from the stationary section by two suspension sets of at least three elongate members of which respective end portions are secured to the stationary section and other end portions are secured to the movable section by means of mechanical connections, one of the sets extending at a side of the optical axis and the other set extending at another, opposite side of the optical axis, wherein the mechanical connections needed for securing at least two elongate members of each set are rigid connections, while at least one of the mechanical connections needed for securing each other elongate member of each set is a flexible connection.

6. The optical device of claim 5, wherein the number of elongate members of each set is three, each member being electrically conducting, and wherein only one of the elongate members of each set is secured by means of a flexible connection.

7. The optical device of claim 5, wherein the flexible connections are provided on the movable section.

8. The optical device of claim 5, wherein each flexible connection comprises a resilient element.
